(19) United States
(12) Patent Application Publication
(10) Pub. No.: US 2007/0234514 A1
(43) Pub. Date: Oct. 11, 2007

(54) Hinge with a multi-stage positioning function

(75) Inventor: Hsiang-Chi Chien, Taipei Hsien (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: SHIN ZU SHING CO., LTD., Shulin City (TW)

(21) Appl. No.: 11/398,178

(22) Filed: Apr. 5, 2006

(51) Int. Cl. E05D 11/10

(52) U.S. Cl. 16/330

(57) ABSTRACT

A hinge with a multi-stage positioning function has a sleeve, a shaft and a positioning spacer assembly. The shaft extends rotatably through the sleeve. The positioning spacer assembly has a first positioning spacer, a second positioning spacer and a third positioning spacer. The first positioning spacer is mounted securely in the sleeve and is mounted around the shaft. Two balls are attached respectively to two opposite surfaces of the first positioning spacer. The second and third positioning spacers are mounted securely on the shaft, are respectively adjacent to the opposite surfaces of the first positioning spacer and respectively have a detent. The detents respectively correspond to and selectively engage the balls and misalign with each other to provide a multi-stage positioning function.

### BACKGROUND OF THE INVENTION

1. Field of the Invention

The present invention relates to a hinge with a multi-stage positioning function, especially to a hinge mounted in an electrical appliance to allow a cover to pivot relative to a base.

2. Description of the Prior Arts

Electrical devices such as notebook computers, cellular phones, etc. comprise a cover, a base and a hinge. The hinge is mounted between the cover and the base to allow the cover to pivot relative to the base. When the cover is closed, the conventional hinge keeps the cover from hitting the base. However, the hinge only uses friction to hold the cover in position when the cover is open and does not provide a positioning function. After the electrical devices are used for a long time, the hinge wears, and the friction of the hinge is not sufficient to hold the cover in position, especially for portable video games having covers that are opened for a long time.

To overcome the shortcomings, the present invention provides a hinge with a multi-stage positioning function to mitigate or obviate the aforementioned problems.

### SUMMARY OF THE INVENTION

The main objective of the present invention is to provide a hinge with a multi-stage positioning function. The hinge with a multi-stage positioning function has a sleeve, a shaft and a positioning spacer assembly. The shaft extends rotatably through the sleeve. The positioning spacer assembly has a first positioning spacer, a second positioning spacer and a third positioning spacer. The first positioning spacer is mounted securely in the sleeve and is mounted around the shaft. Two balls are attached respectively to two opposite surfaces of the first positioning spacer. The second and third positioning spacers are mounted securely on the shaft, are respectively adjacent to the opposite surfaces of the first positioning spacer and respectively have a detent. The detents respectively correspond to and selectively engage the balls and misalign with each other to provide a multi-stage positioning function.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a hinge with a multi-stage positioning function in accordance with the present invention;

FIG. 2 is an exploded perspective view of the hinge in FIG. 1;

FIG. 3 is another exploded perspective view of the hinge in FIG. 1;

FIG. 4 is a side view in partial section of the hinge in FIG. 1;

FIG. 5 is a perspective view of the hinge in FIG. 1 mounted in a cell phone;

FIG. 6 is an exploded perspective view of the first and second positioning spacers of the hinge in FIG. 1; and

FIG. 7 is an exploded perspective view of the second and third positioning spacers of the hinge in FIG. 1.

### DETAILED DESCRIPTION OF THE PREFERRED EMBODIMENTS

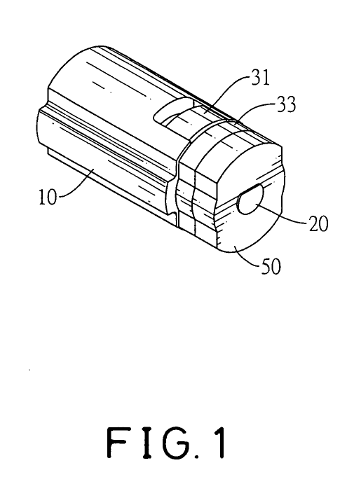

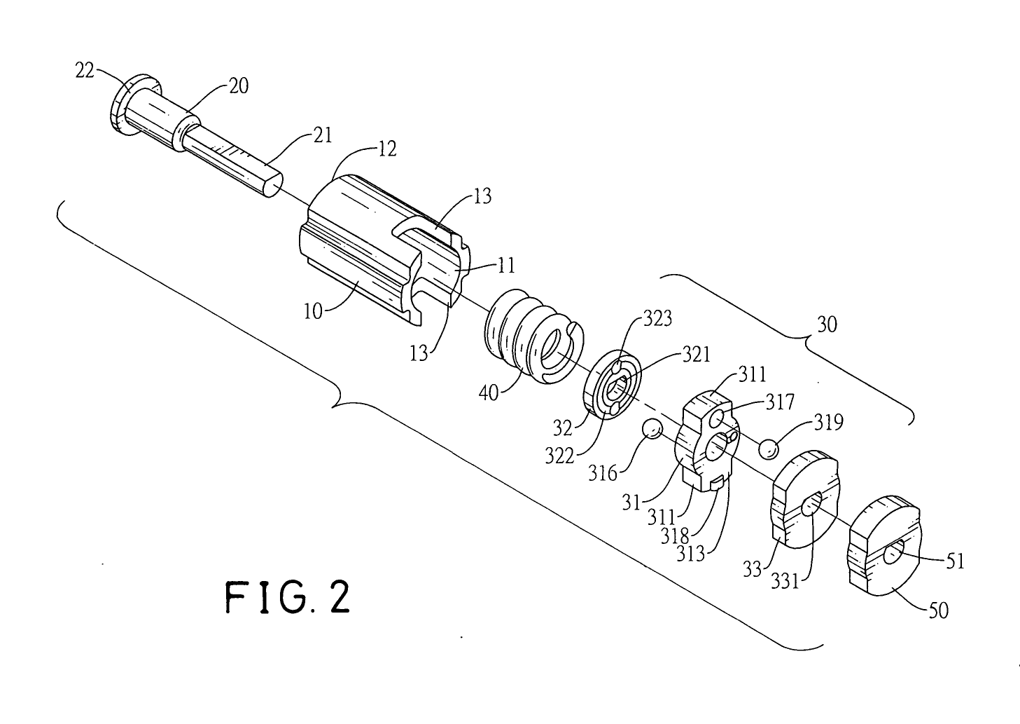

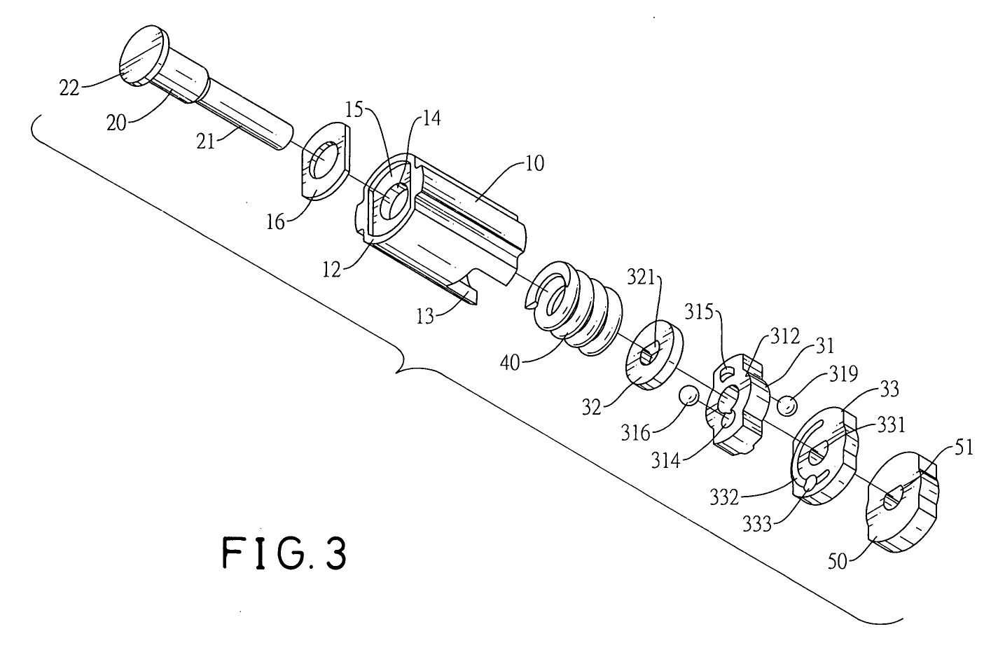

With reference to FIGS. 1-3, a hinge with a multi-stage positioning function in accordance with the present invention comprises a sleeve (10), a shaft (20), a biasing member (40), a positioning spacer assembly (30) and a fastener (50).

The sleeve (10) is hollow and may have an outer wall, an opening end (11), a closed end (12), two notches (13), a through hole (14), a recess (15) and a washer (16). The outer wall of the sleeve (10) may be non-circular. The notches (13) are formed separately in the opening end (11). The through hole (14) is formed through the closed end (12). The recess (15) is formed in the closed end (12). The washer (16) is mounted in the recess (15).

The shaft (20) is mounted rotatably in and extends through the sleeve (10) and may have a first end, a second end, an extension rod (21) and a head (22). The extension rod (21) is non-circular, is formed axially on the first end of the shaft (20) and extends through the through hole (14) in the sleeve (10). The head (22) is formed radially on the second end of the shaft (20) and abuts against the washer (16) in the sleeve (10).

The biasing member (40) is mounted in and abuts against the sleeve (10) and is mounted around the shaft (20). The biasing member (40) may be mounted around the extension rod (21) of the shaft (20), may abut against the closed end (12) of the sleeve (10) and may be a spring.

The positioning spacer assembly (30) is mounted around the shaft (20), abuts against the biasing member (40) and has a first positioning spacer (31), a second positioning spacer (32) and a third positioning spacer (33).

The first positioning spacer (31) is mounted securely in the sleeve (10), is mounted around the shaft (20) and has an edge, two optional protruding parts (311), an inside surface (312), an outside surface (313), an optional inside detent (314), an optional inside protrusion (315), an inside ball (316), an optional outside detent (317), an optional outside protrusion (318) and an outside ball (319). The protruding parts (311) are formed oppositely on and extends radially out from the edge of the first positioning spacer (31) and engage the notches (13) of the sleeve (10) to mount the first positioning spacer (31) securely in the sleeve (10). The inside detent (314) is formed in the inside surface (312) of the first positioning spacer (31). The inside protrusion (315) is formed on the inside surface of the first positioning spacer (31) and is opposite to the inside detent (314). The inside ball (316) is attached to the inside surface (312) of the first positioning spacer (311) and may be mounted securely in the inside detent (314). The outside detent (317) is formed in the outside surface (313) of the first positioning spacer (31). The outside protrusion (318) is formed on the outside surface (313) of the first positioning spacer (31) and is opposite to the outside detent (317). The outside ball (319) is attached to the outside surface (313) of the first positioning spacer (31) and may be mounted securely in the outside detent (317).

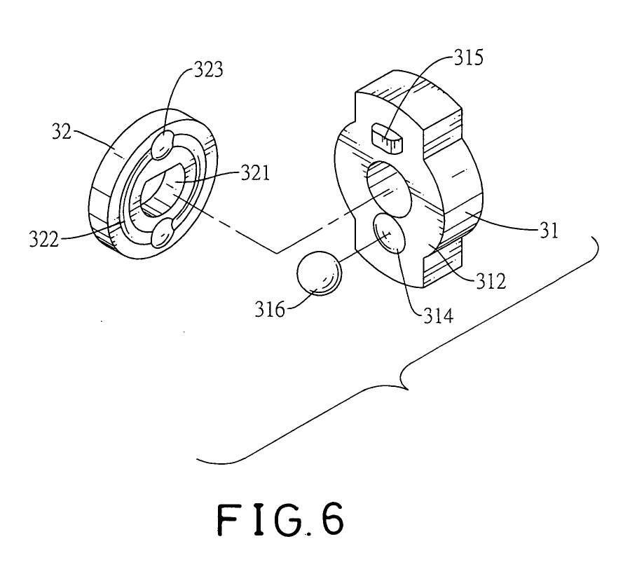

With further reference to FIG. 6, the second positioning spacer (32) is mounted in the sleeve (10), is mounted securely on the shaft (20) adjacent to the first positioning spacer (31), may be mounted securely on the extension rod (21) of the shaft (20), may abut against the biasing member (40), has an outside surface, a primary channel (322) and at least one primary detent (323) and may have a through hole (321). The outside surface of the second positioning spacer (32) faces the inside surface (312) of the first positioning spacer (31). The primary channel (322) is curved and formed in the outside surface of the second positioning spacer (32) and corresponds to the inside ball (316) of the first positioning spacer (31) to provide the inside ball (316) of the first positioning spacer (31) sliding in the primary channel (322). The at least one primary detent (323) is formed in the primary channel (322) of the second positioning spacer (31) and corresponds to and selectively engages the inside ball (316) of the first positioning spacer (31). The through hole (321) is non-circular and is mounted securely on the extension rod (21) of the shaft (20).

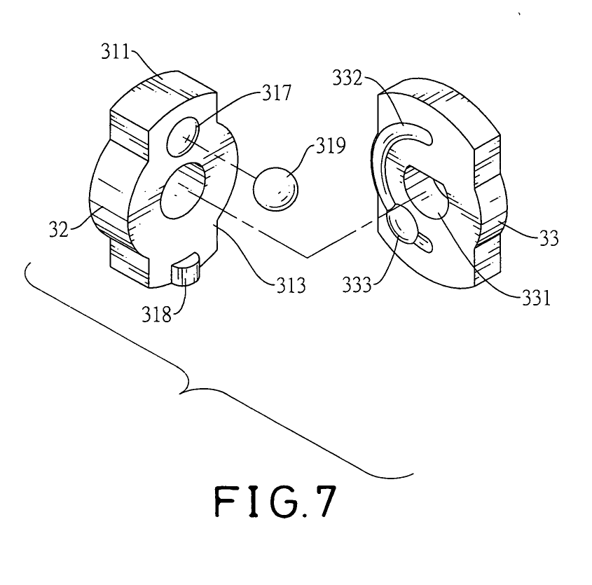

With further reference to FIG. 7, the third positioning spacer (33) is mounted securely on the shaft (20) adjacent to the first positioning spacer (31), may be mounted securely on the extension rod (21) of the shaft (20), has an inside surface, a secondary channel (332) and at least one secondary detent (333) and may have an outer wall and a through hole (331). The inside surface of the third positioning spacer (33) faces to the outside surface (313) of the first positioning spacer (31). The secondary channel (332) is curved formed in the inside surface of the third positioning spacer (33) and corresponds to the outside ball (319) of the first positioning spacer (31) to provide the outside ball (319) sliding in the secondary channel (332). The at least one secondary detent (333) is formed in the secondary channel (332) of the third positioning spacer (33), corresponds to and selective engages the outside ball (319) of the first positioning spacer (31) and misaligns with the at least one primary detent (323) of the second positioning spacer (32). The outer wall of the third positioning spacer (33) may be non-circular. The through hole (331) is non-circular, is formed through the third positioning spacer (33) and is mounted securely on the extension rod (21) of the shaft (20).

The fastener (50) is mounted securely on the shaft (10), may be mounted securely on the extension rod (21) of the shaft (10) to hold the biasing member (40) and the positioning spacer assembly (30) in place and may have an non-circular outer wall.

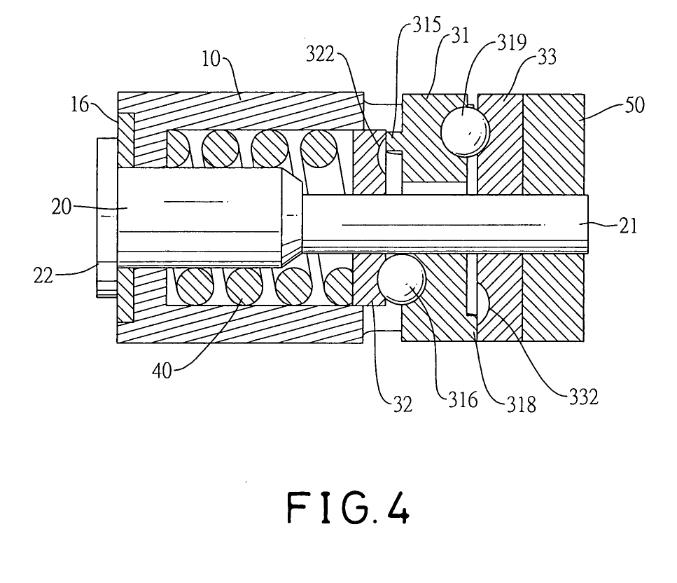

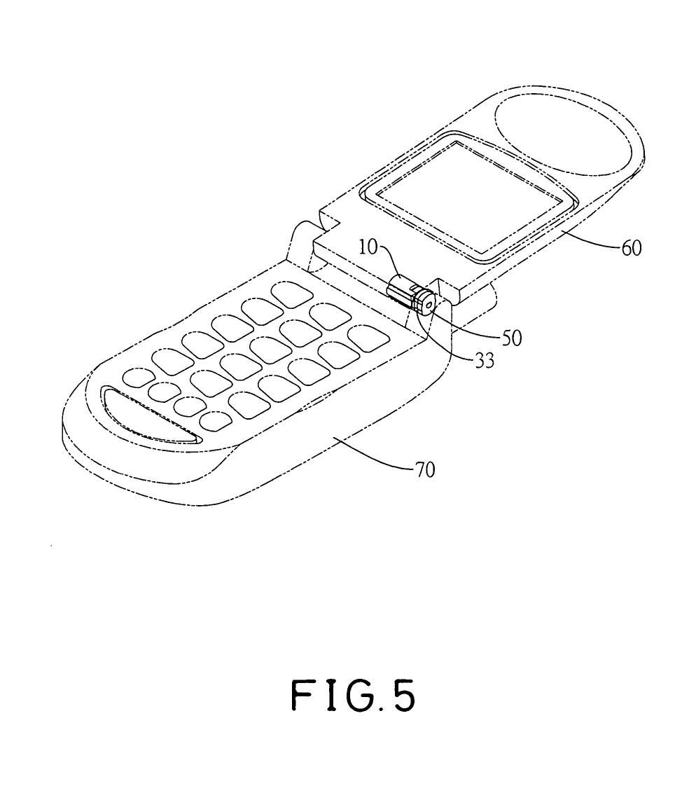

With further reference to FIGS. 4 and 5, the hinge as described in mounted in a cell phone. The cell phone has a cover (60) and a base (70). The fastener (50) and the third positioning spacer (33) are mounted securely in the cover (60) by the non-circular outer walls of the fastener (50) and the third positioning spacer (33). The sleeve (10) is mounted securely in the base (70) by the non-circular outer wall of the sleeve (10). When the cover (60) rotates relative to the base (70), the shaft (20) rotates the second and third positioning spacers (32, 33) relative to the first positioning spacer (31). Then the primary and secondary detents (323, 333) selectively engage the inside and outside balls (316, 319) to provide positioning function. Because the primary and secondary detents (323, 333) misalign with each other, the primary and the secondary detents (323, 333) engage the inside and outside balls (316, 319) at different angles to provide multi-stage positioning function. Therefore, the hinge as described provides multi-stage positioning function to position the cover at multiple angles.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge with a multi-stage positioning function comprising:
a hollow sleeve having a closed end;
a shaft mounted rotatably in and extending through the sleeve;
a biasing member mounted in and abuts against the sleeve and mounted around the shaft;
a positioning spacer assembly mounted around the shaft, abutting against the biasing member and having
a first positioning spacer mounted securely in the sleeve, mounted around the shaft and having
an edge;
an inside surface;
an outside surface;
an inside ball attached to the inside surface of the first positioning spacer; and
an outside ball attached to the outside surface of the first positioning spacer;
a second positioning spacer mounted in the sleeve, mounted securely on the shaft adjacent to the first positioning spacer and having
an outside surface facing the inside surface of the first positioning spacer;
a primary channel being curved and formed in the outside surface of the second positioning spacer and corresponding to the inside ball of the first positioning spacer to provide the inside ball of the first positioning spacer sliding in the primary channel; and
at least one primary detent formed in the primary channel of the second positioning spacer and corresponding to and selectively engaging the inside ball of the first positioning spacer; and
a third positioning spacer mounted securely on the shaft adjacent to the first positioning spacer and having
an inside surface facing to the outside surface of the first positioning spacer;
a secondary channel being curved and formed in the inside surface of the third positioning spacer and corresponding to the outside ball of the first positioning spacer to provide the outside ball sliding in the secondary channel; and
at least one secondary detent formed in the secondary channel of the third positioning spacer, corresponding to and selective engaging the outside ball of the first positioning spacer and misaligning with the at least one primary detent of the second positioning spacer; and
a fastener mounted securely on the shaft to hold the biasing member and the positioning spacer assembly in place.

2. The hinge as claimed in claim 1, wherein the first positioning spacer further comprises
an inside detent formed in the inside surface of the first positioning spacer;
an inside protrusion formed on the inside surface of the first positioning spacer opposite to the inside detent;
an outside detent formed in the outside surface of the first positioning spacer; and
an outside protrusion formed on the outside surface of the first positioning spacer opposite to the outside detent.

3. The hinge as claimed in claim 1, wherein
the sleeve further comprises two notches formed separately in the opening end; and
the first positioning spacer has two protruding parts formed oppositely on and extending radially out from the edge of the first positioning spacer and engaging with the notches of the sleeve.

4. The hinge as claimed in claim 2, wherein
the sleeve further comprises two notches formed separately in the opening end; and
the first positioning spacer has two protruding parts formed oppositely on and extending radially out from the edge of the first positioning spacer and engaging with the notches of the sleeve.

5. The hinge as claimed in claim 1, wherein
the sleeve further comprises
a through hole formed through the closed end of the sleeve;
a recess formed in the closed end of the sleeve; and
a washer mounted in the recess; and
the shaft further comprises
a first end;
a second end;
an extension rod formed axially on the first end of the shaft and extending through the through hole in the sleeve; and
a head formed radially on the second end of the shaft and abutting against the washer in the sleeve.

6. The hinge as claimed in claim 4, wherein
the sleeve further comprises
a through hole formed through the closed end of the sleeve;
a recess formed in the closed end of the sleeve; and
a washer mounted in the recess; and
the shaft further comprises
a first end;
a second end;
an extension rod formed axially on the first end of the shaft and extending through the through hole in the sleeve; and
a head formed radially on the second end of the shaft and abutting against the washer in the sleeve.

7. The hinge as claimed in claim 5, wherein
the extension rod of the shaft is non-circular;
the second positioning spacer has a non-circular through hole formed through the second positioning spacer and mounted securely on the extension rod of the shaft;
the third positioning spacer has a non-circular through hole formed through the third positioning spacer and mounted securely on the extension rod of the shaft; and
the fastener has a non-circular through hole formed through the fastener and mounted securely on the extension rod of the shaft.

8. The hinge as claimed in claim 6, wherein
the extension rod of the shaft is non-circular;
the second positioning spacer has a non-circular through hole formed through the second positioning spacer and mounted securely on the extension rod of the shaft;
the third positioning spacer has a non-circular through hole formed through the third positioning spacer and mounted securely on the extension rod of the shaft; and
the fastener has a non-circular through hole formed through the fastener and mounted securely on the extension rod of the shaft.

9. The hinge as claimed in claim 1, wherein
the sleeve has a non-circular outer wall;
the third positioning spacer has a non-circular outer wall; and
the fastener has a non-circular outer wall.

10. The hinge as claimed in claim 8, wherein
the sleeve has a non-circular outer wall;
the third positioning spacer has a non-circular outer wall; and
the fastener has a non-circular outer wall.
